(19) United States
(12) Patent Application Publication
(10) Pub. No.: US 2003/0126244 A1
(43) Pub. Date: Jul. 3, 2003

(54) APPARATUS FOR SCHEDULED SERVICE OF NETWORK REQUESTS AND A METHOD THEREFOR

(76) Inventors: WILLIAM MEYER SMITH, AUSTIN, TX (US); JOHN JOSEPH EDWARD TUREK, SOUTH NYACK, NY (US)

Correspondence Address: JAMES J MURPHY, 5400 RENAISSANCE TOWER, 1201 ELM STREET, DALLAS, TX, 752702199

(21) Appl. No.: 09/292,191

(22) Filed: Apr. 15, 1999

(51) Int. Cl. G06F 15/173; G06F 9/00

(52) U.S. Cl. 709/223

(57) ABSTRACT

A mechanism for scheduling network requests is implemented. A network server responding to a request from a network client for delivery of a software asset determines if network resource capacity is available to service the request. If the capacity is not available to service the request in real time, the server allocates capacity for future delivery of the asset. The server notifies the client of the time slot containing the allocated bandwidth. The client reinitiates its request at the scheduled time, whereby, because capacity has been preallocated, the scheduled request may be more likely to be serviced in real time.

### TECHNICAL FIELD

The present invention relates in general to data processing systems, and in particular, to a server system on a data processing network.

### BACKGROUND INFORMATION

Data processing systems have evolved dramatically over the past several years. Chief among the abilities of current data processing systems is an ability to access an interface with a number of other data processing systems via a system of connections, commonly referred to as a network. Paradigmatic of this computing environment is the worldwide network of computers commonly known as the “Internet.” The network data processing environment allows client machines on the network with access to software assets in the form of, for example, data, software applications, and distributed data processing.

Typically, the distribution of software over a network uses a “pull” technology in that software downloads are initiated by a server in response to a request from the client. If the server and network have bandwidth resources sufficient to service a client request, it does so, in real time that is, at the time the request is made. Otherwise, the server notifies the client that it is unable to service a request, and the client is left to retry its request at a later time. The time at which the client retries is blindly selected by the client.

As a consequence, software distribution using pull methodologies gives rise to inefficiencies. Bandwidth use is inefficient in that requests making differing demands on the network resources arrive randomly and may fragment the network resources. Furthermore, as the system or network bogs down with workload, response time will increase, as will transmission errors.

Thus, there is a need in the art for apparatus and methods to more efficiently exploit data processing network resources. In particular, there is a need in the art for mechanisms to more efficiently use network resources within a pull technology environment by balancing the network and server workload during periods when the demand on resource bandwidth exceeds the resource's capability to provide that bandwidth in real time.

### SUMMARY OF THE INVENTION

The aforementioned needs are addressed by the present invention. Accordingly, there is provided, in a first form, a method of servicing a network request. The method includes the step of determining availability of resource capacity in response to the request. A scheduled time for resending the network request by a client initiating the request is allocated.

There is also provided, in a second form, a data processing system for servicing a network request. The data processing system contains circuitry operable for determining availability of resource capacity in response to the network request. Circuitry operable for allocating a scheduled time for resending the network request by a client initiating the request is also included.

Additionally, there is provided, in a third form, a program product adaptable for storage on program storage media, the program product operable for servicing a network request, and including programming for determining availability of resource capacity in response to the network request. Programming for allocating a scheduled time for resending the network request by a client initiating the request is also included.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates, in block diagram form, a data processing network in accordance with one embodiment of the present invention;

FIG. 2 illustrates, in block diagram form, a data processing system implemented in accordance with an embodiment of the present invention;

FIG. 3 illustrates, in flowchart form, a methodology implemented to schedule software deployment over a network in accordance with an embodiment of the present invention; and

FIG. 4 schematically illustrates a schedule table in accordance with an embodiment of the present invention.

### DETAILED DESCRIPTION

The present invention provides an apparatus and method for the scheduled service of requests over a network. In response to a client initiated request in which data is to be transferred in bulk for later use, the network server determines if the request can be immediately serviced based on the current and projected workload for the server and network. If the request cannot be immediately accommodated, the server determines a future time slot for the file download. The client initiating the request is informed of the scheduled transfer, and reinitiates its request accordingly.

A more detailed description of the implementation of the present invention will subsequently be provided. Prior to that discussion, an environment in which the present invention may be implemented will be described in greater detail.

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

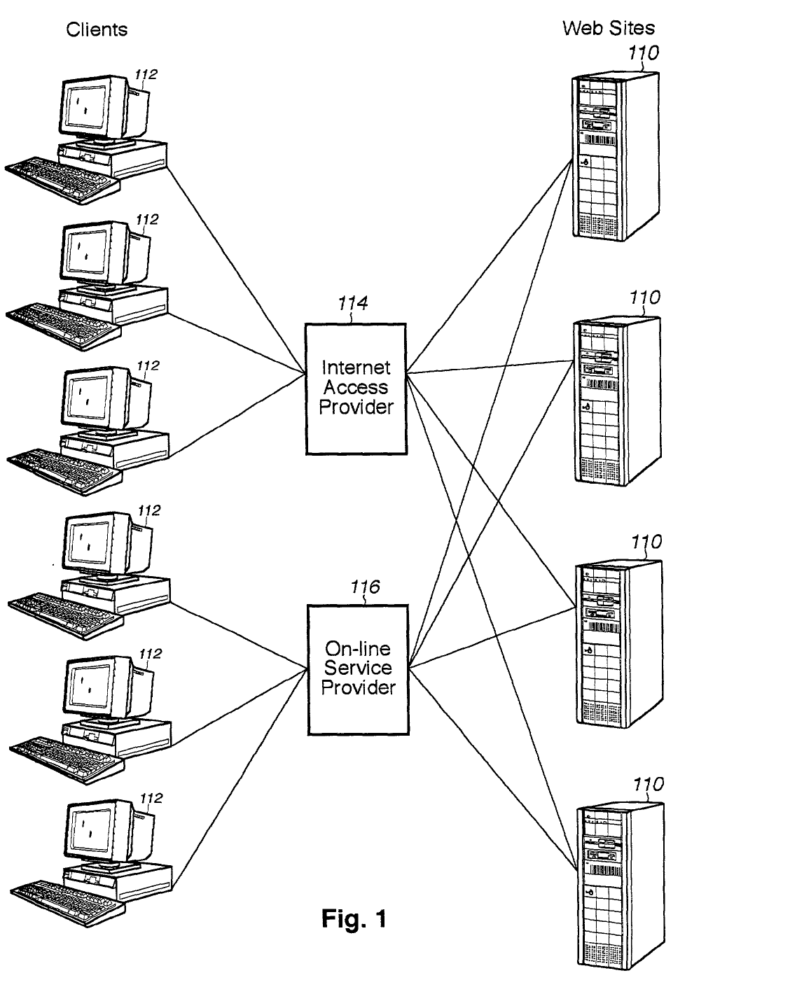

FIG. 1 illustrates a data processing network based on a client-server model typically used in a network environment such as the Internet. The subsequent and description of FIG. 1 are provided to illustrate the environment utilized by the present invention.

Conceptually, the Internet comprises a large network of “servers” 110 that are accessible by “clients” 112. Each of the plurality of clients 112 is typically a user of a personal computer. Clients 112 access the Internet through some private Internet access provider 114 (such as Internet America™) or an on-line service provider 116 (such as America On-Line™, AT&T WorldNet™, and the like). Each of clients 112 may run on a “browser,” which is a known software tool used to access the servers (110) via the access providers (114 and 116). Each server 110 selectively operates a node, such as a “web site,” that supports files in the form of documents, applications and other software assets. Within the worldwide web a network path to a server is identified by a uniform resource locator (URL) having a known syntax for defining a network connection.

As previously mentioned, the World Wide Web is a collection of servers on the Internet that utilizes Hypertext Transfer Protocol (HTTP). HTTP is a known application protocol that provides users access to files using a standard page description language known as Hypertext MarkUp Language (HTML). It should be noted that the files may be in different formats, such as text, graphics, images, sound, video, executable binaries, and the like. HTML provides basic document formatting and allows the developer to specify “links” to other servers or files. Use of an HTML-compliant browser involves specification of a link via the URL. Upon such specification, one of the clients 112 may make TCP/IP request to one of plurality of servers 110 identified in the link and receive a web page (specifically, a document formatted according to HTML) in return. Although the environment has been described in the HTTP context, browsers support other protocols, in addition to HTTP, which provide a context for the present invention, such as the File Transfer Protocol (FTP). FTP is a known protocol for file transfers between Internet servers and clients, which also functions in Internet communication architectures other than the web, for example using the TELNET communication protocol. (TELNET is a known network communications facility using a TCP connection interspersed with its own control information.)

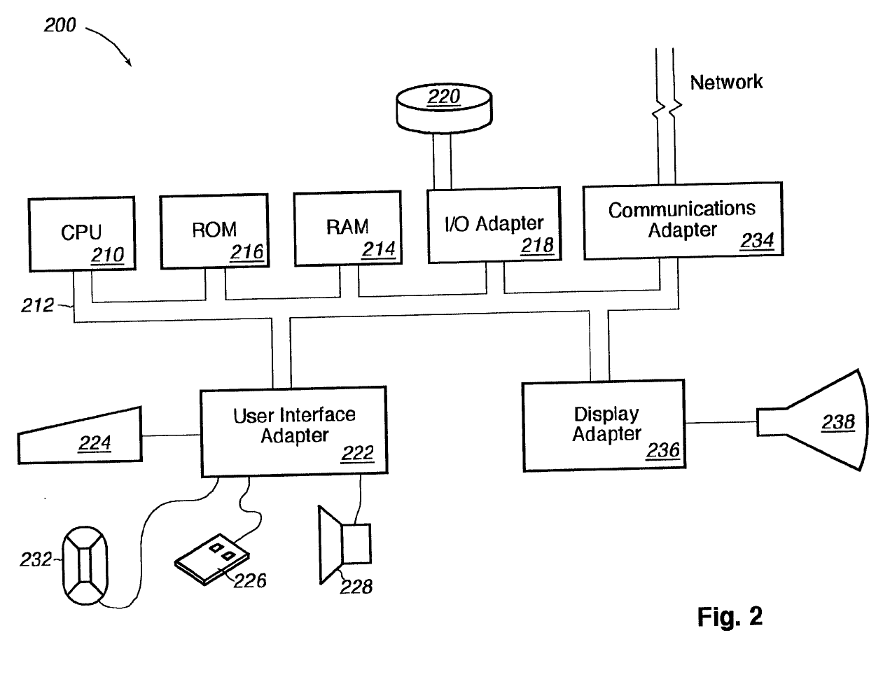

FIG. 2 illustrates a data processor 200 that may be utilized to implement a “server” (110) that executes the methodology of the present invention. Data processing system 200 comprises a central processing unit (CPU) 210, such as a microprocessor. CPU 210 is coupled to various other components via system bus 212. Read-only memory (ROM) 216 is coupled to the system bus 212 and includes a basic input/output system (BIOS) that controls certain basic functions of the data processing system 200. Random access memory (RAM) 214, I/O adapter 218, and communications adapter 234 are also coupled to system bus 212. I/O 218 may be a small computer system interface (SCSI) adapter that communicates with a disk storage device 220. Communications adapter 234 interconnects bus 212 with an outside network enabling the data processing system to communicate with other such systems. Input/output devices are also connected to system bus 212 via user interface adapter 222 and display adapter 236. Keyboard 224, trackball 232, mouse 226, and speaker 228 are all interconnected to bus 212 via user interface adapter 222. Display monitor 238 is coupled to system bus 212 by display adapter 236. In this manner, a user is capable of inputting to the system through keyboard 224, trackball 232, or mouse 226, and receiving output from the system via speaker 228 and display 238.

Some embodiments of the invention include implementations as a computer system program to execute the method or methods described herein, and as a computer program product. According to the computer system implementation, sets of instructions for executing the method or methods are resident in RAM 214 of one or more computer systems configured generally as described above. Until required by the computer system, the set of instructions may be stored as a computer program product in another computer memory. For example, in disk drive 220 (which may include a removable memory such as an optical disk or floppy disk for eventual use in disk drive 220).

Further, the computer program product can also be stored at another computer and transmitted in a computer readable medium when desired to the user's work station by a network or by an external network such as the Internet. One skilled in the art would appreciate that the physical storage of the sets of instructions physically changes the medium upon which it is stored so that the medium carries computer-readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention describes terms such as comparing, validating, selecting, entering, or other terms that could be associated with the human operator. However, at least for a number of the operations described herein which form a part of the present invention, no action by a human operator is desirable. The operations described are, in large part, machine operations processing electrical signals to generate other electrical signals.

The foregoing has provided a general description of a data processing network environment that implements one embodiment of the present invention. Execution and operation of the present invention will subsequently be described in greater detail with respect to each of FIGS. 1-4. As previously mentioned, the data processing apparatus and methods of the present invention provides for scheduled service of network requests. By scheduling the deployment of software assets, the present invention reduces network inefficiency by leveling the workload on network servers and the network. A description of the operation of the data processing apparatus and methodology of the present invention will now be provided in greater detail.

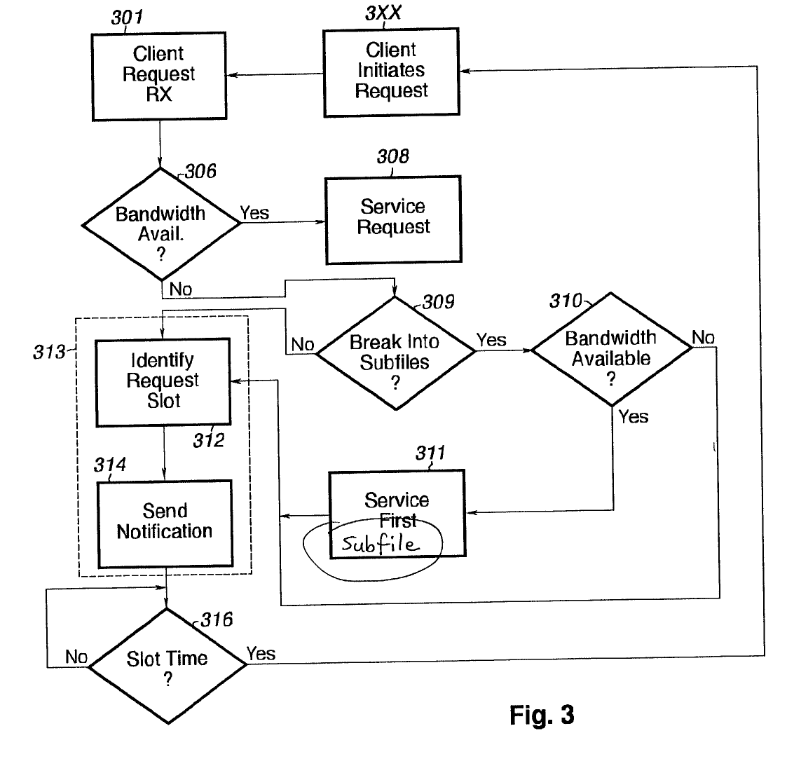

Refer now to FIG. 3 illustrating a flowchart of a scheduling method 300 in accordance with the present invention. In step 302, a client request is initiated which request is received in step 304.

In step 306, the server receiving the request determines whether the bandwidth available to it is adequate to service the request. If the server's current and projected workload, and that of the network, is adequate to service the request, the request is serviced in step 308.

Otherwise, in step 306, method 300 follows the “No” branch, in order to schedule the request.

In step 309, the server determines if a file to be delivered in response to the request received in step 304 may be more quickly serviced by breaking the file into a set of subfiles. A large file might be more efficiently serviced by sending it as a series of subfiles, with scheduled periods for transmission of each of the subfiles. Servicing a large file may be limited by available capacity, or bandwidth, available to service the request in real-time. Furthermore, servicing large files may fragment the capacity of the server, and network, in that the capacity remaining while large requests are being serviced may be insufficient to service other incoming requests. The unused bandwidth may be wasted until the servicing of the large files completes. Allocating server capacity in smaller increments may reduce fragmentation, and thereby more efficiently use the server's resources.

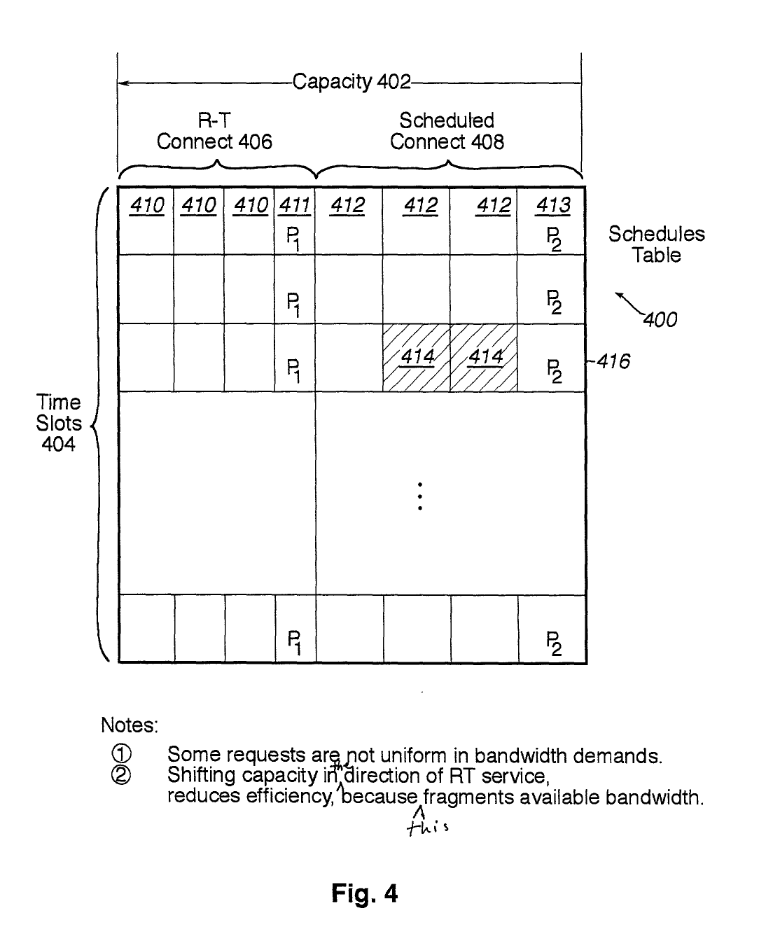

This may be further understood by referring to FIG. 4, schematically illustrating a scheduling table according to the principles of the present invention. The table may be a data structure maintained by the server. Network resources having a predetermined amount of capacity 402 may be allocated in a preselected plurality of increments of time, or time slots 404. Resources include CPU cycles, disk bandwidth, and network bandwidth. The server may account for network capacity by gathering throughput information by monitoring the IP (Internet Protocol) stack. (The IP is a known protocol for delivering information over an interconnected system of networks, such as the Internet.) In an embodiment of the present invention represented by scheduling table 400, resource capacity 402 may be further partitioned into two predetermined portions, a portion 406 allocated to real-time (R-T) connection capacity 406 and scheduled connection portion 408. R-T connections 406 represent bandwidth available for servicing requests in real-time. Schedule connection capacity 408 represents, in any particular time slot 404, capacity allocated to service requests which have been previously deferred and scheduled for servicing in the particular time slot. R-T connection capacity 406 may be further subdivided into a plurality of bandwidth allocations 410, and scheduled connection capacity 408 may be subdivided into a plurality of bandwidth allocations 412. The amount of bandwidth represented by allocations 410 may be different than the amount of bandwidth represented by allocations 412. In this way, an embodiment of the present invention may be configured to more quickly service requests requiring smaller amounts of capacity. In other words, a form of priority scheme may be embedded in the implementation of allocations 410 and 412.

In determining whether a file should be broken into a set of subfiles, in step 309, FIG. 3, the server may make reference to a scheduling table, such as scheduling table 400. Additionally, in determining whether to partition a file into subfiles for scheduled servicing, the server must make an estimate of the time required to service the request, in order to allocate one or more of time slots 404. The estimation of task execution time is a component of task scheduling processes in data processing systems, generally. This is discussed in, for example, U.S. Pat. No. 5,392,430 to Chen, et al., which is hereby incorporated herein by reference.

If, in step 309, method 300 breaks a file request into a set of subfiles, method 300 determines if sufficient bandwidth is available to service a first subfile, in step 310. If so, the first subfile is serviced in step 311, and a message is included notifying the client initiating the request that the request will be serviced as a sequence of subfiles. Method 300 then continues, in step 312, by identifying a service request slot for schedule service of a next subfile. It should be noted that if, in step 309, the requested file was not to be transmitted as a set of subfiles, method 300 would have proceeded via the “No” branch of step 309 to step 312. Therefore, scheduling mechanism 313, including steps 312 and 314, is the same for a request that is to be serviced by delivering a single file, or by delivering a set of subfiles, and will be described generically.

In step 312, a service request slot may be identified by referring to a scheduling table, such as scheduling table 400. A time slot having a sufficient scheduled connect capacity 408 is identified, and the scheduled connect allocations 408 are tagged as having been allocated, here denoted by the shaded allocations 414, in time slot 416. Although scheduled allocations 414 have been shown, in FIG. 4, to span a single time slot, time slot 416, it would be understood that an allocation may span one or more time slots 404. Furthermore, in making the allocations 414, it would be understood that method 300 determines an estimated request execution time, as discussed hereinabove in conjunction with step 310, FIG. 3.

Additionally, an embodiment of the present invention may include a priority mechanism for allocating capacity. For example, subscribers may elect a level of service from among a plurality of service levels. Higher service levels may be associated with higher priority in having requests serviced. Moreover, particular classes of users, such as mobile users, may be assigned a higher priority. In each time slot 404, allocations may be reserved to accommodate higher priority requests. For example, allocation 411 in R-T capacity 406, may be reserved, as denoted by the symbol P₁, and allocation 413 in scheduled capacity 408, reserved as denoted by P₂. In this way, higher priority requests may have a greater likelihood of being serviced in real time or being scheduled earlier for future transfer.

The client initiating the request is notified of the time slot scheduled, such as time slot 416 in scheduling table 400, in step 314. In step 316, the client initiating the request, in step 302, waits until the time represented by the time slot allocated in step 312 arrives. Then, method 300 returns to step 302, wherein the client initiates its request, which request may be for the next subfile in sequence, if the initial request has been broken into subfiles, or for an entire file whose transfer has been previously deferred. Again, in step 304, the request is received, and in step 306, a bandwidth determination is made, as previously described. However, because the required bandwidth has been previously allocated by scheduling mechanism 313, the likelihood that the required bandwidth is available has increased thereby increasing the chance that the “Yes” branch is followed. Then, in step 308, the request is serviced.

In this way, a mechanism for scheduling software downloads is implemented. If a client request cannot be immediately serviced because of the unavailability of sufficient resources, a time slot for future services allocated, and the requested client is informed thereof. The client then reinitiates its request, at the allotted time. Because the required bandwidth has been previously allocated, the likelihood that the reinitiated request will be serviced is increased. Moreover, the need for randomly reinitiated blind requests which may be likely to be fruitless are no longer necessary. Furthermore, the fragmentation of resource capacity is reduced because in any given time slot, a mix of requests requiring different amounts of resource bandwidth can be scheduled whereby wasted capacity is reduced.

Although the present invention and its advantages have been described in detail, it should be understood that various changes, substitutions and alterations can be made herein without departing from the spirit and scope of the invention as defined by the appended claims.

What is claimed is:

1. A method of servicing a network request comprising the steps of:
determining availability of resource capacity in response to said network request; and
allocating a scheduled time for resending said network request by a client initiating said request.

2. The method of claim 1 wherein said step of allocating a schedule time comprises the steps of:
selecting said scheduled time; and
notifying said client to resend said network request at said scheduled time.

3. The method of claim 2 wherein said step of selecting said scheduled time comprises the step of selecting said scheduled time from a preselected plurality of time slots.

4. The method of claim 1 further comprising the steps of:
breaking a file requested in said network request into a set of subfiles, wherein said network request scheduled for resending comprises a request to send a preselected subfile of said set of subfiles.

5. The method of claim 1 further comprising the step of servicing said request in real time when resource capacity is available.

6. The method of claim 2 wherein each time slot includes a first portion having a first preselected proportion of a predetermined network resource capacity, said first portion comprising a portion reserved for servicing requests in real time.

7. The method of claim 2 wherein each time slot includes a first portion having a first preselected proportion of a predetermined network resource capacity, said first portion comprising a portion reserved for servicing at least one scheduled request.

8. The method of claim 6 wherein said first portion includes a second portion reserved for servicing requests having a first priority.

9. The method of claim 7 wherein said first portion includes a second portion reserved for servicing requests having a first priority.

10. A data processing system for servicing a network request comprising:
circuitry operable for determining availability of resource capacity in response to said network request; and
allocating a scheduled time for resending said network request by a client initiating said request.

11. The data processing system of claim 10 wherein said circuitry operable for allocating a schedule time comprises:
circuitry operable for selecting said scheduled time; and
circuitry operable for notifying said client to resend said network request at said scheduled time.

12. The data processing system of claim 11 wherein said circuitry operable for selecting said scheduled time comprises circuitry operable for selecting said scheduled time from a preselected plurality of time slots.

13. The data processing system of claim 10 further comprising:
circuitry operable for breaking a file requested in said network request into a set of subfiles, wherein said network request scheduled for resending comprises a request to send a preselected subfile of said set of subfiles.

14. The data processing system of claim 10 further comprising circuitry operable for servicing said request in real time when resource capacity is available.

15. The data processing system of claim 11 wherein each time slot includes a first portion having a first preselected proportion of a predetermined network resource capacity, said first portion comprising a portion reserved for servicing requests in real time.

16. The data processing system of claim 11 wherein each time slot includes a first portion having a first preselected proportion of a predetermined network resource capacity, said first portion comprising a portion reserved for servicing at least one scheduled request.

17. The data processing system of claim 15 wherein said first portion includes a second portion reserved for servicing requests having a first priority.

18. The method of claim 16 wherein said first portion includes a second portion reserved for servicing requests having a first priority.

19. A program product adaptable for storage on program storage media, the program product operable for servicing a network request, the program product comprising:
programming for determining availability of resource capacity in response to said network request; and
programming for allocating a scheduled time for resending said network request by a client initiating said request.

20. The program product of claim 19 wherein said programming for allocating a schedule time comprises:
programming for selecting said scheduled time; and
programming for notifying said client to resend said network request at said scheduled time.

21. The program product of claim 20 wherein said programming for selecting said scheduled time comprises programming for selecting said scheduled time from a preselected plurality of time slots.

22. The program product of claim 19 further comprising programming for:
breaking a file requested in said network request into a set of subfiles, wherein said network request scheduled for resending comprises a request to send a preselected subfile of said set of subfiles.

23. The program product of claim 19 further comprising programming for servicing said request in real time when resource capacity is available.

24. The program product of claim 20 wherein each time slot includes a first portion having a first preselected proportion of a predetermined network resource capacity, said first portion comprising a portion reserved for servicing requests in real time.

25. The program product of claim 20 wherein each time slot includes a first portion having a first preselected proportion of a predetermined network resource capacity, said first portion comprising a portion reserved for servicing at least one scheduled request.

26. The program product of claim 24 wherein said first portion includes a second portion reserved for servicing requests having a first priority.

27. The program product of claim 25 wherein said first portion includes a third portion second portion reserved for servicing requests having a first priority.

28. A data processing system comprising:
a network;
a client coupled to said network; and
a server coupled to said network, said client including circuitry operable for sending a request for delivery of software assets over said network to said server, wherein said server includes circuitry operable for scheduling said request for delayed servicing in response to insufficient system capacity, and circuitry for sending a notification to said client to resend said request according to said scheduling

29. The data processing system of claim 28 wherein said request is scheduled for servicing at a preselected time.

30. The data processing system of claim 28 wherein said client further includes circuitry operable for resending said request in response to said notification.

31. The data processing system of claim 28 wherein said network comprises the Internet.

32. The data processing system of claim 28 wherein said server further includes circuitry operable for breaking said software asset into a plurality of subfiles, wherein said request for resending comprises a request for a preselected subfile of said plurality.
